(19) United States
(12) Patent Application Publication
(10) Pub. No.: US 2017/0288341 A1
(43) Pub. Date: Oct. 5, 2017

(54) HOUSING FOR CONNECTING TO A PLUG CONNECTOR PART

(71) Applicant: Phoenix Contact GmbH & Co. KG, Blomberg (DE)

(72) Inventor: Manuel Tuenker, Doerentrup (DE)

(21) Appl. No.: 15/507,276

(22) PCT Filed: Aug. 26, 2015
(86) PCT No.: PCT/EP2015/069507

§ 371 Date: Feb. 28, 2017

(30) Foreign Application Priority Data
Sep. 2, 2014 (DE) 10 2014 112 631.9

(51) Int. Cl. H01R 13/64; H01R 13/627; H01R 13/6596

(52) U.S. Cl. CPC H01R 13/64; H01R 13/6596; H01R 13/627

(57) ABSTRACT

A housing for connecting to a plug connector part includes a plug-in opening, into which the plug connector part can be plugged in a plug-in direction; a wall which surrounds the plug-in opening; and a coding device which has at least one coding projection that protrudes inwards from the wall into the plug-in opening transversely to the plug-in direction and is designed to allow the plug connector part to be plugged into the plug-in opening in a specified angular position about the plug-in direction. The wall may have a first wall portion and a second wall portion which adjoins the first wall portion axially in the plug-in direction. The second wall portion may be offset outwards relative to the first wall portion in a direction transverse to the plug-in direction.

### CROSS-REFERENCE TO RELATED APPLICATIONS

This application is a U.S. national stage application under 35 U.S.C. §371 of International Application No. PCT/EP2015/069507, filed on Aug. 26, 2015, and claims benefit to German Patent Application No. DE 10 2014 112 631.9, filed on Sep. 2, 2014. The International Application was published in German on Mar. 10, 2016, as WO 2016/034466 A1 under PCT Article 21(2).

### FIELD

The invention relates to a housing for connecting to a plug connector part.

### BACKGROUND

A housing of this kind comprises an insertion opening into which the plug connector part can be inserted in an insertion direction. The insertion opening is surrounded by a wall, which can be, for example, cylindrical or can have a different shape, and which defines the insertion opening. A coding apparatus is also provided that comprises at least one coding protrusion which protrudes inwards from the wall into the insertion opening transversely to the insertion direction. The coding apparatus is designed to allow the plug connector part to be inserted into the insertion opening in a predetermined angular position about the insertion direction.

The coding apparatus ensures that the plug connector part can only be inserted into the insertion opening in one or more separate, predefined angular positions. Corresponding protrusions and/or grooves are provided on the plug connector part and can be brought into operative connection, with an interlocking fit, to the at least one coding protrusion of the coding apparatus such that the plug connector part can only be inserted into the insertion opening in the one or more predefined angular positions and, additionally, when in the inserted state, the plug connector part is held in its angular position relative to the insertion opening.

The housing can, for example, be a component of an electrical device. An electrical cable, for example, can be connected to the electrical device by means of the plug connector part that can be inserted into the insertion opening, and therefore electrical signals, for example data signals, or an electric power supply can be transmitted by means of the plug-in connector provided by the housing and the plug connector part.

A housing of this type that can be connected to one or more plug connector parts by means of a plug-in connection can be used, for example, in wind turbines or in other electrical devices that are subjected to varying environmental conditions, for example varying temperatures, during operation. In this respect, a shielding plate and a printed circuit board can be connected to the housing, for example, to which shielding plate and printed circuit board the plug connector part is connected when inserted into the insertion opening.

While the housing is made of plastics material for example, a shielding plate is expediently made from metal, for example. This can result in the material of the housing and the material of the shielding plate having significantly different thermal expansion coefficients, which may result in the housing and the shielding plate expanding or shrinking to different extents under changing environmental conditions. In turn, this can result in quite considerable forces acting on the plug connector parts inserted into the insertion openings in the housing, which forces are caused by changes in position between the shielding plate and the housing under changing environmental conditions, for example as a result of a changing ambient temperature.

DE 20 2010 015 623 U1 discloses a trailer connector for a vehicle, in which receiving channels for plug-in contacts are formed on a connector housing.

DE 43 43 209 A1 discloses a supply connector comprising a housing. The supply connector can be used, for example, to charge an electric vehicle.

### SUMMARY

An aspect of the invention provides a housing for connection to a plug connector part, the housing comprising: an insertion opening into which the plug connector part can be inserted in an insertion direction; a wall surrounding the insertion opening; and a coding apparatus including a coding protrusion which protrudes inwards from the wall into the insertion opening transversely to the insertion direction. The coding protrusion is configured to allow the plug connector part to be inserted into the insertion opening in a predetermined angular position about the insertion direction. The wall includes a first wall portion and a second wall portion, axially adjoining the first wall portion in the insertion direction. The second wall portion is offset from the first wall portion towards the outside in a direction transverse to the insertion direction.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a view of an embodiment of a housing comprising a plurality of insertion openings for inserting associated plug connector parts;

FIG. 2 is a front view of an insertion opening in the housing;

FIG. 3 is an exploded view of the housing in the region of an insertion opening;

FIG. 4 is a side view of the housing in the region of an insertion opening;

FIG. 5A is a separate view of the housing, without a shielding plate arranged thereon and a printed circuit board, in the region of an insertion opening;

FIG. 5B is a sectional view along the line A-A according to FIG. 5A;

FIG. 5C is a rear view of the housing in the region of the insertion opening;

FIG. 6A-B are perspective views of a plug connector part for insertion into an insertion opening in the housing;

FIG. 7 is a side view of the plug connector part;

FIG. 8A is a separate view of an adjustment part of the plug connector part;

FIG. 8B is an exploded view of parts of a plug-in assembly of the plug connector part; and

FIG. 9 is a front view of an insertion head of the plug connector part.

### DETAILED DESCRIPTION

An aspect of the present invention provides a housing for use with a plug connector part, an electrical device comprising a housing of this kind, and an assembly comprising a housing and a plug connector part, which housing, electrical device and assembly can be used even in environments where environmental conditions change significantly and temperatures vary, and provide a secure, reliable and rigid connection between a plug connector part and a housing.

Therefore, in the housing, the wall comprises a first wall portion and a second wall portion which adjoins the first wall portion axially in the insertion direction, the second wall portion being offset from the first wall portion towards the outside in a direction transverse to the insertion direction.

The second wall portion being offset from the first wall portion towards the outside is understood to mean that, when viewed from inside the insertion opening, the second wall portion is offset from the first wall portion towards the rear. If the wall is substantially cylindrical, the second wall portion is radially offset towards the outside. Therefore, the insertion opening is wider in the region of the second wall portion than in the region of the first wall portion.

In particular, the insertion opening has a first opening width at the first wall portion and a second opening width at the second wall portion that is larger than the first opening width, as measured in a direction transverse to the insertion direction.

An aspect of the present invention provides, on an insertion opening in a housing into which a plug connector part can be inserted, a wall portion that has a larger opening width than another wall portion of the insertion opening. In this respect, the first opening width of the first wall portion can be adapted to an insertion head of the plug connector part that is to be inserted into the insertion opening, such that the opening width at the first wall portion substantially corresponds to the external diameter of the insertion head (comprising coding protrusions that may be arranged thereon).

The first wall portion is in front of the second wall portion when viewed in the insertion direction, and therefore, when being inserted, the plug connector part is first introduced into the insertion opening, with an approximately exact fit, in the region of the first wall portion. In this process, one or more coding protrusions of the coding apparatus of the insertion opening may fit perfectly with corresponding coding elements on the insertion head of the plug connector part, and therefore the plug connector part is inserted into the insertion opening in a defined angular position.

When fully inserted, the insertion head of the plug connector part, preferably in particular together with coding elements arranged thereon, comes to be positioned in the region of the second wall portion which has an increased opening width. Owing to the second wall portion being offset towards the outside, this does not result in the plug connector part being secured in the insertion opening with an exact fit when fully inserted; instead, there is (slight) clearance relative to the wall of the insertion opening in this fully inserted state.

Owing to the clearance between the wall of the insertion opening and the insertion head of the plug connector part inserted therein, the insertion head is able to move (slightly) in the insertion opening during operation. If, during operation, changing environmental conditions cause a change in the position between, for example, a shielding plate, to which the plug connector part is connected when inserted, and the housing as a result of the shielding plate and the housing expanding to different extents, for example, due to changes in temperature, this change in position can be compensated for by the plug connector part moving in the insertion opening in the housing, without this producing (excessive) forces between the plug connector part and the housing or the shielding plate.

Therefore, as a result of the different opening widths at the different wall portions, effects resulting from the different materials of the shielding plate and the housing, for example, having different thermal expansion coefficients can be compensated for.

In an advantageous embodiment, the wall is, for example, substantially cylindrical at the first wall portion and at the second wall portion thereof. In this case, the first opening width corresponds to the diameter of the insertion opening at the first wall portion, whereas the second opening width corresponds to the diameter of the insertion opening at the second wall portion. In this case, the first diameter at the first wall portion is smaller than the second diameter at the second wall portion, and therefore the insertion opening widens towards the second wall portion.

The coding apparatus comprises at least one, preferably a plurality of, coding protrusions which protrude inwards from the wall and are shaped such that they define, together with the plug connector part, one or more defined angular positions in which the plug connector part can be inserted into the insertion opening. The at least one coding protrusion preferably extends in the insertion direction to the wall of the insertion opening, it being possible, in an advantageous embodiment, for the coding protrusion to extend substantially to the second wall portion.

In this case, the at least one coding protrusion can preferably extend over the entire height of the second wall portion, as measured in the insertion direction.

Two or more coding protrusions are advantageously provided that together form the coding apparatus. In this case, a coding groove is formed between every two coding protrusions, which groove extends longitudinally in the insertion direction and into which an associated coding protrusion on the insertion head of the plug connector part can be pushed, which protrusion is in the form of an elongate coding rib for example. In an inserted state, the coding protrusion of the plug connector part is positioned in the associated coding groove of the housing such that, as a result of this, the angular position of the plug connector part is fixed relative to the housing.

A coding groove formed between two coding protrusions preferably comprises, on the inlet side, an entry point, the width of which, as measured in the circumferential direction about the insertion direction, is smaller than the width of the coding groove adjoining the entry point. When a plug connector part is inserted into the insertion opening, this results in coding elements on the insertion head of the plug connector part initially fitting perfectly with the entry points of associated coding grooves, and thus, during insertion, a precisely defined angular position is initially assumed. Upon further insertion, the coding elements on the insertion head of the plug connector part reach the region of the coding grooves and are subsequently positioned, with clearance, in the associated coding grooves after having passed an associated entry point.

This thus creates clearance between the inserted plug connector part and the wall of the housing opening, in both the transverse direction and the circumferential direction, and therefore, when fully inserted, the plug connector part can move, at least slightly, in the associated insertion opening.

In an advantageous embodiment, the entry point is arranged on the first wall portion. Therefore, when coding elements on the insertion head of the plug connector part reach the region of the entry point, the insertion head is inserted, with an exact fit, into the insertion opening in a defined angular position until the fully inserted position is reached, once said coding elements have passed the entry points.

A plurality of coding grooves of the coding apparatus are preferably offset from one another on the wall of the insertion opening in the circumferential direction about the insertion direction. In this respect, the coding grooves can differ from one another particularly with respect to their widths as measured in the circumferential direction. Additionally or alternatively, the angular spacings between the grooves can also differ. As a result, it is possible to predetermine precisely one angular position in which a plug connector part can be inserted into an associated insertion opening in the housing.

If the coding grooves are formed on the second wall portion, the opening width at the second wall portion can be measured in particular between (approximately) opposite coding grooves. The opening width at the second wall portion is thus measured between the bases of opposite coding grooves.

An electrical device preferably comprises a housing of the above-described type and a shielding plate, which extends in a plane transverse to the insertion direction, is connected to the wall of the housing and adjoins the wall when viewed in the insertion direction. The housing can be made of plastics material for example, while the shielding plate is made of a metal material, for example steel or copper. Accordingly, the housing and the shielding plate may have significantly different thermal expansion coefficients, and this can result in the shielding plate and the housing expanding or shrinking to different extents during operation under changing environmental conditions, in particular at changing temperatures.

The shielding plate preferably defines the insertion opening in the housing in the insertion direction. The shielding plate thus forms a rear wall of the insertion opening and thus defines the depth of the insertion opening. One or more engagement openings are made in the shielding plate, in which openings one or more latch elements of the plug connector part can engage in a latching manner. Therefore, by means of the shielding plate, the plug connector part can be locked in the insertion opening in a latching manner, and therefore, once the plug connector part has been inserted into the insertion opening, the plug connector part cannot readily be removed from the insertion opening, at least not without releasing the latched connection.

The insertion opening in the housing functions as a mating plug connector part for the plug connector part and creates a socket into which the plug connector part can be inserted in order to establish an electrical connection, for example. For this purpose, a contact pin comprising one or more electric contacts can be arranged on the shielding plate. The contact pin extends in the insertion direction from the shielding plate into the insertion opening and, when the plug connector part is inserted into the insertion opening, connects to an associated contact part of the plug connector part, and therefore, when the plug connector part is inserted, contacts of the contact pin are electrically contacted to contacts of the contact part of the plug connector part on sides of the housing.

The electrical device can be a component of a wind turbine, for example, or of another electrical installation. The electrical device can comprise, for example, an electronic part that comprises a printed circuit board and electrical and electronic components arranged thereon. The printed circuit board is preferably arranged at a spacing (of greater than zero) from the shielding plate and is located behind the shielding plate, when viewed in the insertion direction, such that the shielding plate shields the printed circuit board towards the outside. The shielding plate is used in particular for electromagnetic shielding and suppresses the immission of electromagnetic interfering signals to the printed circuit board and/or the emission of electromagnetic interfering signals from the electrical device.

An assembly comprises a housing or an electrical device of the above-described type and additionally one or more plug connector parts that can be brought into plugged engagement with one or more insertion openings in the housing. A plurality of insertion openings, for example, can be provided in the housing for connection to a plurality of plug connector parts, it being possible for the insertion openings to be provided in the housing in an ordered manner (for example in an arrangement having several lines of insertion openings).

Each plug connector part comprises an insertion head, at least one coding rib preferably being arranged on the insertion head, extending in the insertion direction and being able to be brought into engagement with a coding groove on the insertion opening. The coding rib which engages in an associated coding groove thus makes it possible for the plug connector part to only be inserted into an associated insertion opening in one or more angular positions. When inserted, the plug connector part is held in its angular position by means of the coding rib positioned in the associated coding groove.

The coding rib preferably extends longitudinally on the insertion head of the plug connector part in the insertion direction over an extension length. In this case, the extension length of the coding rib is preferably no larger than the height of the associated coding groove (likewise measured in the extension direction). If the coding groove is formed on the second wall portion of the insertion opening in the housing, when the plug connector part is fully inserted, the coding rib on the insertion head of the plug connector part comes to be positioned entirely in the region of the second wall portion and the coding groove arranged thereon, and thus, owing to the increased opening width in the region of the second wall portion, there is clearance between the insertion head and the wall of the insertion opening. This makes it possible to compensate for changes in the position of the plug connector part relative to the housing, if, for example, the shielding plate and the housing expand to different extents under changing environmental conditions.

The length of the at least one coding rib is preferably shorter than the overall length of the insertion head (when viewed in the insertion direction). Therefore, the coding rib only extends over part of the insertion head.

The plug connector part preferably comprises at least one latch element which is arranged on a plug-in assembly and can be brought into latching engagement with the housing. The latch element can, for example, comprise one or more spring arms on each of which a latching lug is formed for latched connection to an associated engagement opening in the housing or shielding plate.

In an advantageous embodiment, the plug connector part can constitute what is referred to as a “push-pull” plug-in connector, for example, which comprises a plug-in assembly, which also comprises the latch element, and an adjustment part which can be adjusted relative to the plug-in assembly and is in the form of a sliding sleeve or the like. In order to establish the plugged connection between the plug connector part and the housing, the plug connector part can be inserted into an associated insertion opening in the insertion direction, the latch element coming into latching engagement with the housing or the shielding plate. In order to release the connection between the plug connector part and the housing, the adjustment part is actuated and acts on the latch element when actuated such that the latched connection between the latch element and the housing or the shielding plate is released and the plug connector part can therefore be removed from the insertion opening counter to the insertion direction. Such a plug-in connector operating according to the “push-pull” principle allows the plug connector part to be inserted in a simple manner with a secure and reliable connection and additionally allows the connection to be released in a simple manner by actuating the adjustment part.

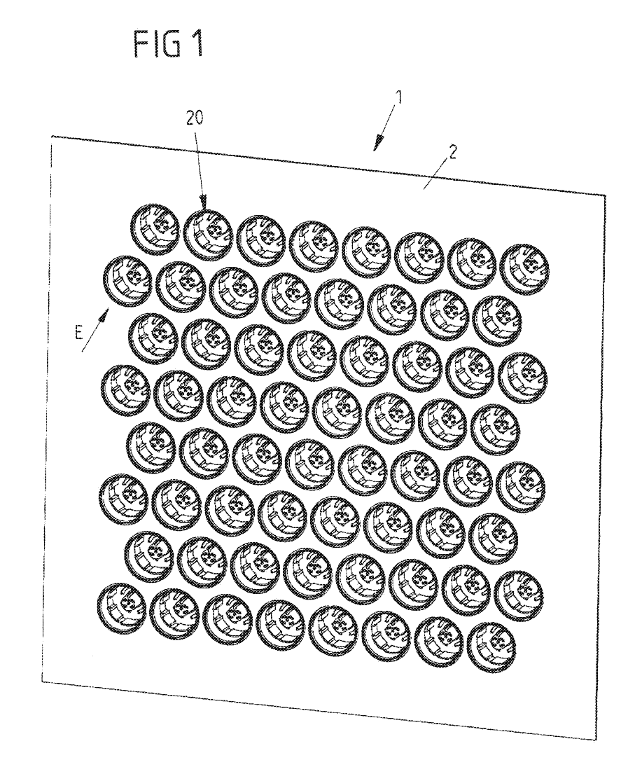

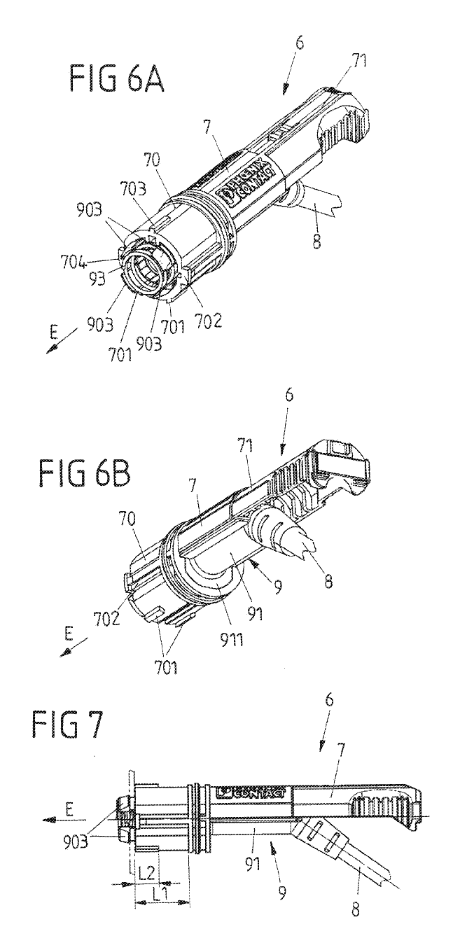

FIG. 1 is a general view of a housing 2 which is a component of an electrical device 1. The electrical device can, for example, be a component of a wind turbine or the like and can comprise various electrical and/or electronic components that can be connected to external assemblies by means of plug connector parts 6 (see FIGS. 6A and 6B) that are to be inserted into insertion openings 20 in the housing 2 in an insertion direction E, in order to provide signal linking and/or an electric power supply or the like.

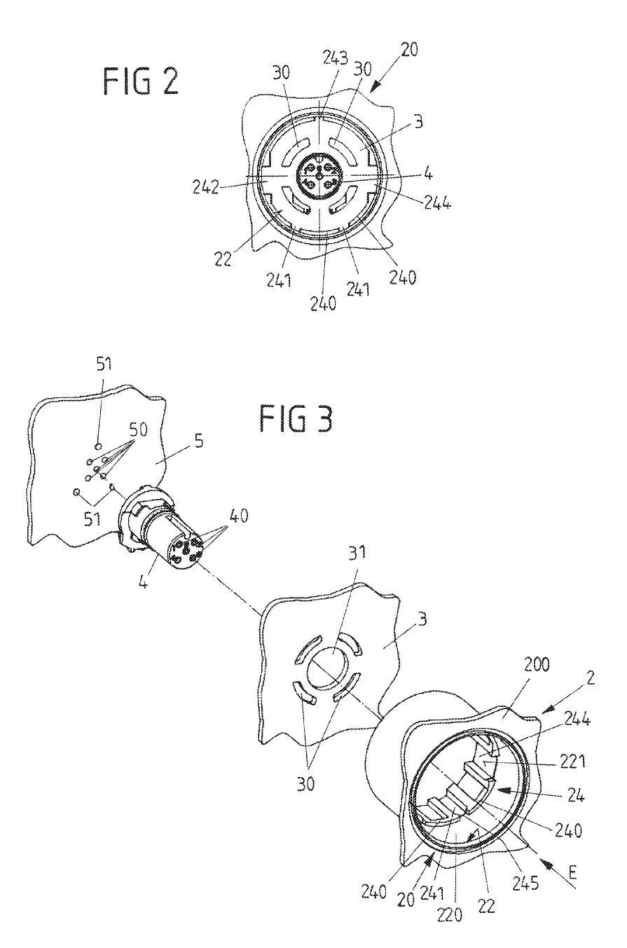

FIG. 2 to FIG. 5A-5C are different views of the housing 2 in the region of an insertion opening 20. Each insertion opening 20 is designed to receive one plug connector part 6. The insertion opening 20 is, in principle, cylindrical and has a circular cross section, the insertion opening 20, as shown in FIG. 3 for example, extends from a front surface 200 in the insertion direction E and is delimited by a substantially cylindrical wall 22.

As can be seen in FIG. 3, the wall 22 is substantially cylindrical, coding protrusions 240 of a coding apparatus 24 being arranged on the wall 22 and defining an angular position in which a plug connector part 6 can be inserted into the insertion opening 20.

As can be seen in FIG. 2, a total of five coding protrusions 240 are formed on the wall 22 and protrude radially inwards from the wall 22 into the region of the insertion opening 20. The coding protrusions 240 form five coding grooves 241-244 therebetween that can be brought into engagement with associated coding ribs 701-704 on an insertion head 70 of the plug connector part 6. The coding grooves 241-244 each extend longitudinally in the insertion direction E and allow the plug connector part 6 to be inserted, by its insertion head 70 and the coding ribs 701-704 arranged thereon, into the insertion opening 20 in the insertion direction E in precisely one angular position about the insertion direction E.

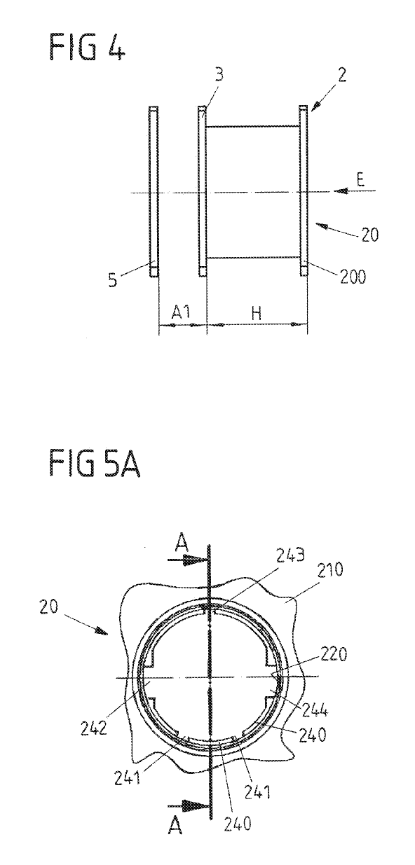

As can be seen in FIG. 3, a shielding plate 3 that extends transversely to the insertion direction E adjoins the wall 22 of the insertion opening 20. The shielding plate 3 is positioned on an end face of the wall 22 that faces away from the front surface 200 (see for example FIG. 4) and thus defines the insertion opening 20 on the rear side in the insertion direction E.

While the housing 2 can be made of plastics material for example, the shielding plate 3 is preferably made of a metal, for example copper or steel. The shielding plate 3 is used to electromagnetically shield components of the electrical device 1 from the external environment outside the electrical device 1.

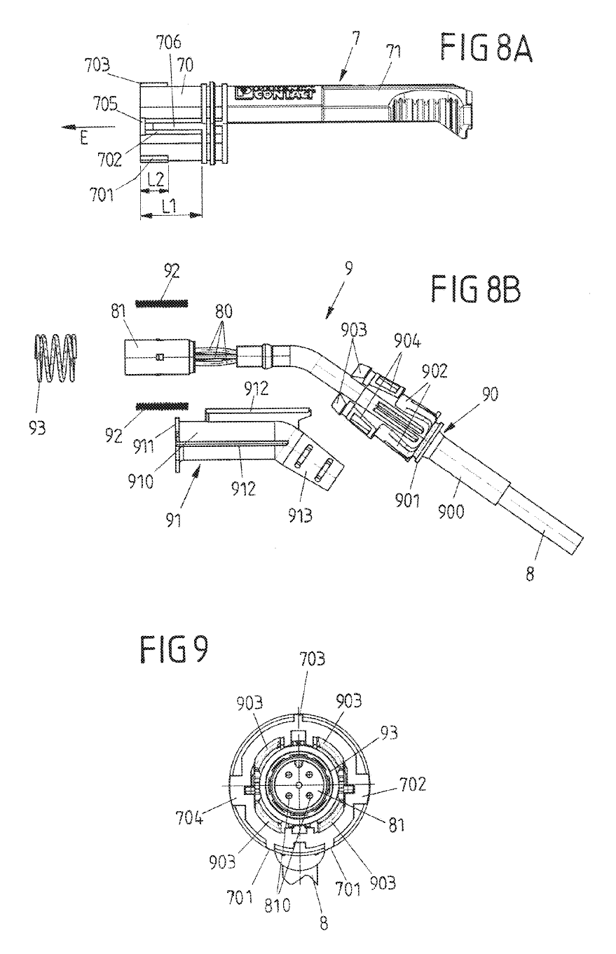

The shielding plate 3 comprises a central opening 31 through which a contact pin 4 passes. The contact pin 4 is substantially cylindrical and carries a plurality of contacts 40 that can be electrically contacted with associated contacts of a contact part 81 (see FIG. 8B) of the plug connector part 6.

The contact pin 4 is connected to a printed circuit board 5 via fastening points 51. The printed circuit board 5 has contact points 50 which are associated with the contacts 40 of the contact pin 4 and are used to electrically contact the contacts 40 on sides of the printed circuit board 5. Cable cores, for example, can be guided through the contact points 50. Alternatively, an electrical connection, for example a scarf joint, can be established at the contact points 50.

As can be seen in FIG. 4, when viewed in the insertion direction E, the printed circuit board 5 is arranged behind the shielding plate 3 at a spacing A1. The main body of the printed circuit board 5 can be made of a conventional printed circuit board material, for example FR4.

As can be seen in FIG. 3, engagement openings 30 are arranged around the central opening 31 in the shielding plate 3 and are used to receive, in a latching manner, latch lugs 903 of a latch element 90 of the plug connector part 6 (see FIGS. 6A and 8B). The engagement openings 30 are thus used to establish a latched connection with the plug connector part 6. When in the inserted state, the latch lugs 903 of the plug connector part 6 that project from the insertion head 70 engage in the associated engagement openings 30 in the shielding plate 3 and the plug connector part is, in this manner, interlockingly connected to the shielding plate 3.

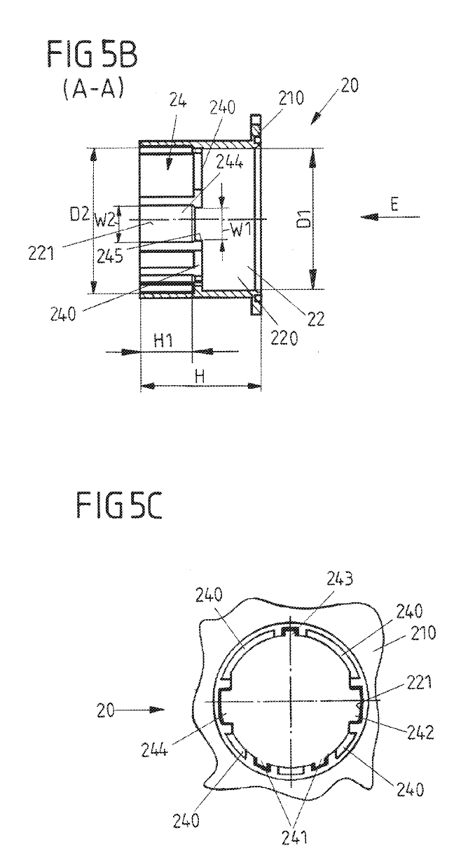

The wall 22 which defines the insertion opening 20 is formed by two different wall portions 220, 221. In this case, a second wall portion 221 axially adjoins a first wall portion 220 in the insertion direction E, has a diameter D2 that is larger than the diameter D1 of the first wall portion 220 and thus has a larger opening width, as can be seen in the sectional view according to FIG. 5B.

As can be seen in FIG. 3 and FIG. 5B, there is a step between the first wall portion 220 and the second wall portion 221 on the coding grooves 241-244. In particular, the insertion opening 20 widens at the transition between the first wall portion 220 and the second wall portion 221 such that the second wall portion 220 is radially offset towards the outside.

In this case, the coding protrusions 240 extend over the height H1 of the second wall portion 221, and therefore the coding grooves 241-244 are formed on the second wall portion 221.

An entry point 245 for each coding groove 241-244 is located at the transition between the first wall portion 220 and the second wall portion 221, but still on the first wall portion 220, and represents the entrance into the particular coding groove 241-244, through which entry point an associated coding rib 701-704 on the insertion head 70 has to be pushed when the plug connector part 6 is being inserted. As can be seen in particular in FIG. 5B, the entry point 245 has a width W1 that is smaller than the width W2 of the axially adjoining coding groove 241-244, when viewed in the circumferential direction about the insertion direction E.

As a result of the second wall portion 221 having a larger diameter D2 than the first wall portion 220 in the region of the coding grooves 241-244 arranged on said second wall portion, when the plug connector part 6 is fully inserted, i.e. when the insertion head 70 of the plug connector part 6 is fully inserted into the insertion opening 20, there is clearance between the insertion head 70 and the wall 22 of the insertion opening 20. The coding ribs 701-704 extend on the insertion head 70 over a length L2 (see FIG. 8A) that corresponds to the height H1 of the coding grooves 241-244 or is smaller than the height H1. When the plug connector part 6 is fully inserted, the coding ribs 701-704 come to be positioned in the region of the coding grooves 241-244 and, as a result, are positioned in the coding grooves 241-244 with clearance owing to the increased diameter D2 of the second wall portion 221 and the width W2 of the coding grooves 241-244 that is larger than that of the entry point 245.

This makes it possible, for example, to compensate for a change in position between the shielding plate 3 and the housing 2 which occurs under changing environmental conditions, for example at changing temperature conditions, by the insertion head 70 of the plug connector part 6 being able to move (slightly) in the associated insertion opening 20.

If there is a change in temperature, the shielding plate 3 generally expands (or shrinks) in a different manner to the housing 2 if the material of the shielding plate 3 and the material of the housing 2 have different thermal expansion coefficients. Since the latch lugs 903 of the plug connector part 6 engage in the shielding plate 3 in a latching manner, the position of the plug connector part 6 together with the shielding plate 3 changes, and therefore the plug connector part 6 may change position relative to the housing 2. This is possible in the region of the clearance between the insertion head 70 and the insertion opening 20, without this producing (excessive) forces between the plug connector part 6 and the housing 2.

The axial length L1 of the insertion head 70 substantially corresponds to the overall height H of the insertion opening 20 (cf. FIG. 5B and FIG. 7).

When the plug connector part 6 is being inserted into an associated insertion opening 20, the insertion head 70, together with the coding ribs 701-704 arranged thereon, is first inserted into the first wall portion 220. The plug connector part 6 can then be brought into the correct, defined angular position in which the coding ribs 701-704 fit with the entry points 245 on the inlet side of the coding grooves 241-244.

Owing to the reduced width W1 at the entry points 245 by comparison with the coding grooves 241-244, the coding ribs 701-704 are, in this case, in the (at least approximately) exact angular position, and therefore the insertion head 70 is inserted with an exact fit.

Upon further insertion, the coding ribs 701-704 are pushed into the associated coding grooves 241-244 until the coding ribs 701-704 come to be positioned entirely in the region of the coding grooves 241-244 when the insertion head 70 is fully inserted. Since the coding ribs 701-704 have, in that case, passed the entry points 245 and are thus no longer positioned in the region of the entry points 245, there is clearance between the coding ribs 701-704 and the coding grooves 241-244 and thus, overall, there is clearance between the insertion head 70 and the wall 22 of the insertion opening 20.

FIGS. 6A and 6B to 9 are different views of a plug connector part 6 which is to be inserted into an insertion opening 20 in the housing 2.

The plug connector part 6 is designed in accordance with the “push-pull principle” and comprises a plug-in assembly 9 on which an adjustment part 7 in the form of a sliding sleeve is arranged so as to be slidable in the insertion direction E. As can be seen in the exploded view according to FIG. 8B, the plug-in assembly 9 comprises a latch element 90 which comprises a shaft 900 and spring arms 902 that extend from the shaft 900. Latch lugs 903 are formed on the spring arms 902 and can be brought into latching engagement with the engagement openings 30 in the shielding plate 3 on sides of the electrical device 1, in order to lock the plug connector part 6 to the housing 2.

The latch element 90 is arranged on a contact part 81 and the spring arms 902 of which latch element engage over the contact part 81. When the plug connector part 6 is assembled, the shaft 900 comes to be positioned in the region of freely extending cable cores 80 between the contact part 81 and a coated cable 8 and covers these cable cores 80 on their free path of extension between the contact part 81 and the coated cable 8.

A housing part 91 is arranged on the shaft 900, covers the shaft 900 and comprises guide ribs 912 along which the adjustment part 7 is slidably guided. The housing part 91 forms a sleeve 910 which receives the shaft 900 therein and joins to a collar 901 of the shaft 900 by means of a collar 911. An attachment piece 913 which extends at an angle to the sleeve 910 defines a bend in the cable 8 on the plug connector part 6 (see for example FIG. 6B).

The adjustment part 7 forms the insertion head 70 comprising the coding ribs 701-704 arranged thereon.

Whereas, in this case, the coding ribs 701, 703 extend longitudinally on the insertion head 70 over the length L2 which corresponds to the height H1 of the coding grooves 241-244, the coding ribs 702, 704 comprise a coding head 705 and an elongate portion 706 which adjoins thereto (see FIG. 8A). In this case, the dimensions of the coding head 705 transverse to the insertion direction E are larger than the elongate portion 706 and the width of said coding head is adapted to the width W1 of the entry point 245 of the associated coding groove 242, 244. If when inserting the insertion head 70 into the insertion opening 20, the coding head 705 has passed the associated entry point 245, the elongate portion 706 is positioned in the entry point 245 with clearance, and therefore, when the insertion head 70 is fully inserted, the insertion head 70 is able to move relatively in the insertion opening 20 transversely to the insertion direction E.

The adjustment part 7 is resiliently preloaded with respect to the plug-in assembly 9 by means of spring elements 92, and therefore, once the adjustment part 7 has been actuated counter to the insertion direction E, the adjustment part 7 automatically returns to its starting position.

In order to connect the plug connector part 6 to the electrical device 1, the plug connector part 6 is inserted, by the insertion head 70, into an insertion opening 20 in the housing 2 in the insertion direction E, until the insertion head 70 comes to be positioned entirely in the insertion opening 20. In this inserted state, contacts 810 of the contact part 81 are electrically contacted with contacts 40 of the contact pin 4 on sides of the electrical device 1. Furthermore, the latch lugs 903 engage in the engagement openings 30 in the shielding plate 3, and therefore a latched connection is established between the plug connector part 6 and the shielding plate 3.

In order to release the plug connector part 6 from the electrical device 1, the adjustment part 7 is moved relative to the plug-in assembly 9 counter to the insertion direction E by a user pulling, for example, on an actuation part 71 of the adjustment part 7 that adjoins the insertion head 70. As a result, the adjustment part 7 strikes chamfers 904 on the spring arms 902 of the latch element 90 (the spring arms 902 come to be positioned in the region of the insertion head 70 when the plug connector part 6 is assembled, inside which insertion head suitable actuation elements are provided for acting on the chamfers 904). As a result, the spring arms 902, together with the latch lugs 903 arranged thereon, are pressed towards the inside radially to the insertion direction E and are thus brought out of engagement with the engagement openings 30, and therefore the plug connector part 6 can be removed from the insertion opening 20 counter to the insertion direction E.

The contact part 81 is surrounded by a spring element 93 which is in the form of a coil spring, abuts the shielding plate 3 when the plug connector part 6 is inserted and creates spring preload between the insertion head 70 and the shielding plate 3 counter to the insertion direction E. This spring preload removes clearance from the latched connection between the plug connector part 6 and the shielding plate 3 and assists with removal of the plug connector part 6.

The basic concept of the invention is not limited to the embodiments described above, but can also in principle be implemented in completely different embodiments.

In particular, the insertion opening, in principle, does not have to be cylindrical, but may, for example, instead be polygonal, for example square or oval.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SIGNS

1 device
2 housing
20 insertion opening
200 front surface
22 wall
220 wall portion
221 wall portion
24 coding apparatus
240 coding protrusion
241-244 coding groove
245 entry point
3 shielding plate
30 engagement openings
31 opening
4 contact pin
40 contacts
5 printed circuit board
50 contact points
51 fastening points
6 plug connector part
7 adjustment part
70 insertion head
701-704 coding rib
705 coding head
706 elongate portion
71 actuation part
8 cable
80 cable cores
81 contact part
810 contacts
9 plug-in assembly
90 latch element
900 shaft
901 collar
902 spring arms
903 latch lugs
904 chamfers
91 housing part
910 sleeve
911 collar
912 guide rib
913 attachment piece
92 spring element
93 spring element
A1 spacing
D1, D2 diameter
E insertion direction
H, H1 height
L1, L2 length
W1, W2 width

1: A housing for connection to a plug connector part, the housing comprising:
an insertion opening into which the plug connector part can be inserted in an insertion direction;
a wall surrounding the insertion opening; and
a coding apparatus including a coding protrusion which protrudes inwards from the wall into the insertion opening transversely to the insertion direction,
wherein the coding protrusion is configured to allow the plug connector part to be inserted into the insertion opening in a predetermined angular position about the insertion direction,
wherein the wall includes a first wall portion and a second wall portion, axially adjoining the first wall portion in the insertion direction, and
wherein the second wall portion is offset from the first wall portion towards the outside in a direction transverse to the insertion direction.

2: The housing of claim 1, wherein the insertion opening has a first opening width at the first wall portion and a second opening width at the second wall portion,
wherein the second opening width is larger than the first opening width as measured transversely to the insertion direction.

3: The housing of claim 2, wherein the wall is substantially cylindrical at the first wall portion and at the second wall portion, and
wherein the first opening width corresponds to a diameter of the insertion opening at the first wall portion and the second opening width corresponds to a diameter of the insertion opening at the second wall portion.

4: The housing of claim 1, wherein the coding protrusion extends in the insertion direction over an entire height of the second wall portion, as measured in the insertion direction.

5: The housing of claim 1, wherein the coding apparatus includes at least two coding protrusions that form a coding groove therebetween that extends in the insertion direction.

6: The housing of claim 5, wherein the coding groove has a first width, as measured in a circumferential direction about the insertion direction,
wherein the coding groove adjoins an entry point, when viewed in the insertion direction, and
wherein the entry point has a second width that is smaller than the first width, as measured in the circumferential direction.

7: The housing of claim 6, wherein the entry point is arranged on the first wall portion.

8: The housing of claim 1, wherein the coding apparatus includes a plurality of coding grooves which are offset from one another in a circumferential direction about the insertion direction.

9: The housing of claim 8, wherein at least two of the coding grooves have different widths as measured in the circumferential direction.

10: The housing of claim 1, wherein the second wall portion has a larger opening width than the first wall portion, as measured between coding grooves which are opposite one another within the insertion opening in a direction transverse to the insertion direction.

11: An electrical device, comprising:
the housing claim 1; and
a shielding plate which extends transversely to the insertion direction,
wherein the shielding plate is connected to the wall of the housing, and
wherein the shielding plate adjoins the wall when viewed in the insertion direction.

12: The electrical device of claim 11, wherein the shielding plate defines the insertion opening in the insertion direction, and
wherein the shielding plate includes an engagement opening configured to receive a latch element of the plug connector part in a latching manner.

13: The electrical device of claim 11, further comprising:
a contact pin, which extends in the insertion direction from the shielding plate into the insertion opening, connected to the shielding plate, and
wherein the contact pin includes an electric contact.

14: The device of claim 11, further comprising:
a printed circuit board arranged at a spacing from the shielding plate when viewed in the insertion direction.

15: An apparatus, comprising:
the housing of claim 1; and
the plug connector part, configured to be brought into plugged engagement with the insertion opening in the housing.

16: The apparatus of claim 15, wherein the plug connector part includes an insertion head and a coding rib arranged on the insertion head,
wherein the coding rib extends in the insertion direction, and
wherein the coding rib can be brought into engagement with a coding groove on the insertion opening.

17: The apparatus of claim 16, wherein an extension length of the coding rib, as measured in the insertion direction, is no larger than a height of the coding groove, as measured in the insertion direction.

18: The apparatus of claim 17, wherein the insertion head has a length, as measured in the insertion direction, the length of the insertion head substantially corresponding to the height of the wall of the housing, as measured in the insertion direction,
wherein the extension length of the coding rib is shorter than the length of the insertion head.

19: The apparatus of claim 15, wherein the plug connector part includes a latch element arranged on a plug-in assembly,
wherein the latch element can be brought into latching engagement with the housing,
wherein the plug connector part further includes an adjustment part that can be adjusted relative to a plug-in assembly, and
wherein the adjustment part is configured to act on the latch element when actuated in order to release an engagement between the latch element and the housing.
